(19) United States
(12) Patent Application Publication
(10) Pub. No.: US 2024/0391383 A1
(43) Pub. Date: Nov. 28, 2024

(54) METHOD AND DEVICE FOR DETECTING A LIVING BEING, AND VEHICLE

(71) Applicant: HELLA GmbH & Co. KGaA, Lippstadt (DE)

(72) Inventors: Bansal MAMTA, Pune (IN); Etienne COSTA-PATRY, Berlin (DE); Esakki Ponraj ESAKKIMUTHU, Berlin (DE); Richard GIESE, Berlin (DE); Sven LIEBAU, Berlin (DE)

(73) Assignee: HELLA GmbH & Co. KGaA, Lippstadt (DE)

(21) Appl. No.: 18/794,454

(22) Filed: Aug. 5, 2024

Related U.S. Application Data
(63) Continuation of application No. PCT/EP2023/051649, filed on Jan. 24, 2023.

(30) Foreign Application Priority Data
Feb. 3, 2022 (DE) 10 2022 102 552.7

(51) Int. Cl. B60Q 9/00; G01V 3/12; G08B 21/02

(52) U.S. Cl. CPC B60Q 9/00; G01V 3/12; G08B 21/02

(57) ABSTRACT

A method and a device for detecting a living being, in particular a small child, in a vehicle. A transmitter provides a signal that is influenced by the living being. The influenced signal is provided to a receiver that provides the signal to a first decision module. The first decision module uses the signal to ascertain whether a vital state of a living being is present. The signal is provided to a second decision module if a living being is ascertained, wherein the second decision module ascertains whether the living being is an adult. If it is ascertained that the living being is not an adult, a warning signal is output using a signal generator. A vehicle having such a device is also provided.

This nonprovisional application is a continuation of International Application No. PCT/EP2023/051649, which was filed on Jan. 24, 2023, and which claims priority to German Patent Application No. 10 2022 102 552.7, which was filed in Germany on Feb. 3, 2022, and which are both herein incorporated by reference.

### BACKGROUND OF THE INVENTION

### Field of the Invention

The invention relates to a method and to a device for detecting a living being. Further, the invention relates to a vehicle.

### Description of the Background Art

It is desirable to detect living beings in a car, especially in cars in warm countries. To this end, children or animals (pets) in particular, which do not make themselves known if the driver leaves the car, should be detected so that no risk of danger to the living being in question is to be expected, even at increased interior temperatures in the vehicle.

Further, vehicles already have a large number of sensors in the interior to monitor the interior of a vehicle. As a rule, living beings are detected on the basis of their vital functions (movement).

### SUMMARY OF THE INVENTION

It is therefore an object of the invention to use sensors to detect a living being in an interior of a vehicle.

In particular, it is an object of the invention to detect a small child in a vehicle.

The object is achieved with the aid to detect a living being, in particular to detect a small child in a vehicle. In this method, a transmitter provides a signal, wherein the signal is influenced by the living being, wherein the influenced signal is provided to a receiver, wherein the receiver provides the signal to a first decision module, wherein the first decision module uses the signal to ascertain whether a vital state of a living being is present, wherein the signal is provided to a second decision module if a living being is ascertained, wherein the second decision module ascertains whether the living being is an adult, wherein if it is ascertained that the living being is not an adult, a warning signal is output using a signal generator.

A particularly accurate decision can be made by means of the two-stage decision—first whether it is a living being at all and then whether it is an adult or a small child.

The use of two decision modules simplifies the decision. By simplifying the decision, less computing power is required for the respective decision module.

A differentiation of the living being-whether it is an adult or a small child-occurs advantageously on the basis of the respiratory rate or the heart rate and/or the size of the living being or any other modulation of the signal.

The decision modules are advantageously designed as software modules, wherein the decision modules are integrated into a computer program product.
1. A transmitter advantageously emits a signal or a signal sequence,
2. The signal is advantageously detected by a receiver,
3. The received signal is advantageously analyzed with the help of decision modules:
A. The signal is advantageously examined for modulated oscillations.
B. In particular, a frequency of the (modulated) oscillations is determined.
C. It can be determined based on the frequency whether the oscillation has been modulated onto the signal on the basis of a vital state of the living being.

Preferably, it is determined in a first step whether the signal is influenced by a living being at all. An interaction between the signal and the living being advantageously occurs in such a way that the living being is positioned between the transmitter and the receiver.

The signal is advantageously used to detect a movement of the living being. Such a movement can be caused by breathing or by a heartbeat.

An analysis of the signal, whether an oscillation has been modulated, occurs advantageously with the aid of an analysis of a Fourier spectrum.

Advantageously, a first step takes place, whether a living being is present in a vehicle at all.

Then it is advantageously determined whether the living being is an adult.

Alternatively, it can be determined advantageously whether the living being is a small child.

Alternatively, it can be advantageously determined whether the living being is another animal (pet), for example, a dog.

As an example, the signal is provided with the aid of a UWB transmitter. The signal is advantageously detected with a UWB receiver.

The modulated oscillation as part of the detected signal is preferably in the range of 0.1 to 2 Hertz, or corresponds to the heart rate or respiratory rate of the detected living being.

Accordingly, the vital state is a heartbeat or a movement of the respective surface—especially the chest—of the living being.

The detection is carried out with the aid of a computer program product that performs at least parts of the method. Preferably, the computer program product is installed and executable on a computer unit.

In an example of the invention, the signal is an ultra-wideband signal. An ultra-wideband signal is also referred to as a UWB signal.

Advantageously, UWB receivers and UWB transmitters are already located in a motor vehicle and therefore do not need to be integrated additionally into a vehicle.

The first decision module can comprise a Fourier transform. Slow changes in the signal can be detected using the Fourier transform.

Optionally, the first decision module can also comprise a frequency filter or noise suppression.

The detection of a living being per se can be greatly simplified by a simply constructed first decision module.

The second decision module can comprise a learning algorithm. Advantageously, the second decision module is at least essentially based on a learning algorithm.

The classification of adults can be done easily with the help of a learning algorithm. Advantageously, the decision whether it is a small child can also be unnecessary; if there is a living being in a vehicle who is not an adult, an alarm signal can be provided immediately. The detection reliability is thus considerably increased.

The second decision module can decide whether the living being is an adult or a small child based on a respiratory rate and/or a heart rate of the living being.

Advantageously, the second decision module can also make a direct decision as to which type of living being is involved.

Depending on the learning algorithm used, a greater accuracy can thus be realized.

The respective decision module can be integrated into a control device, in particular a control device of the vehicle.

An especially easy integration of the existing decision module into an often already existing computing unit of a vehicle control unit takes place by the integration into the vehicle.

The signal can be provided to a third decision module, wherein the third decision module ascertains whether the living being is a small child.

Whether the living being is a small child can be directly determined with use of the third decision module. The signal can be provided by the second decision module. Advantageously, the signal is provided by the second decision module when the first decision module has already ascertained a living being and/or the second decision module has determined that the living being is not an adult.

A particularly low-error detection of a small child in a vehicle can be ensured by the direct determination of the small child.

A warning signal can be output if a small child is detected and/or if it is ascertained that the living being is not an adult. The warning signal can advantageously be transmitted to a cell phone or an emergency number. Alternatively or in addition, the warning signal can be provided by the horn or by the vehicle's lighting system.

Other parameters such as the closed state of vehicle doors and/or the outside temperature can be taken into account when selecting the warning signal.

The third decision module can comprise a Fourier transform and/or a learning algorithm.

Advantageously, the third decision module can have a learning algorithm, wherein the learning algorithm of the third decision module is based on a specifically learned algorithm. Advantageously, the third decision module can be provided to make a distinction between an adult and a small child based on the signal provided to it.

The device for detecting a living being comprises a transmitter and a receiver, wherein the transmitter is designed to provide a signal, in particular an ultra-wideband signal, wherein the receiver is designed to receive the signal, wherein the device comprises a first decision module and a second decision module, wherein the receiver is designed to provide the signal to the first decision module, wherein the first decision module is designed to ascertain whether the signal comprises an indication of a living being, wherein the first decision module is designed to provide the signal to the second decision module if a living being is ascertained, wherein the second decision module is provided to ascertain whether the living being is an adult, wherein the device further comprises a signal generator, wherein the signal generator is provided to output a warning signal if the living being is not an adult.

Advantageously, transmitters and receivers are used that are already present in a vehicle.

Preferably, the device is integrated into a control system of the vehicle. Communication between the sensors and the respective decision module preferably takes place via a vehicle bus such as, for example, a CAN bus.

The device can comprise a computing unit, wherein the respective decision module is installed and executable as a computer program on the computing unit. The computing unit is advantageously designed to carry out at least a substantial part of the method.

The above-mentioned object of the invention can also be achieved by means of a control device for a vehicle, wherein the vehicle control system comprises at least the first and second decision module, and wherein the control device can be connected to the transmitter and the receiver via an interface.

The device can have a third decision module, wherein the third decision module is provided and configured to ascertain whether the living being is a small child based on the signal provided.

The third decision module can be configured to decide whether the living being is a small child or an adult on the basis of the signal.

The third decision module can be designed to decide only whether the living being is a small child or not.

An increased accuracy in the detection of a living being is possible with the use of a third decision module.

The vehicle advantageously has a device as described above or a control device as described above.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an exemplary decision scheme;

FIG. 2 shows a further exemplary decision scheme; and

FIG. 3 shows a vehicle.

### DETAILED DESCRIPTION

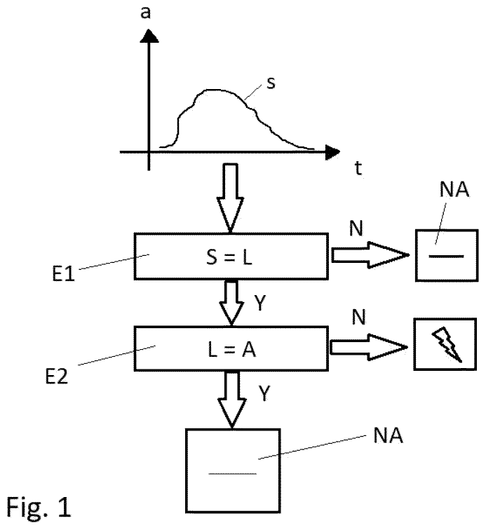

FIG. 1 shows an exemplary decision scheme. In a first step, a receiver 14 provides the signal S to a first decision module E1. The signal S is advantageously an amplitude A as a function of time t. The signal S can also be an amplitude A as a function of a number of variables such as time t and frequency f.

The first decision module E1 decides on the basis of an oscillation or other anomaly of the signal S whether a living being L is within the range of receiver 14.

If no oscillation or other anomaly is ascertained in the signal S, the result can be discarded and no further action is taken. In particular, the signal S is advantageously not forwarded to the second decision module E2. Optionally, a notification is sent to an additional module NA, wherein the additional module NA does not provide a warning signal. The additional module can be designed as a signal generator 16.

If the first decision module E1 ascertains an oscillation or an anomaly in the signal S, the signal S is provided to a second decision module E2. The second decision module E2 is used to decide whether the living being L is a small child KK or an adult A. Advantageously, the second decision module E2 is designed and configured to ascertain whether the living being L is an adult A.

If the second decision module E2 ascertains that the living being is not an adult A, a warning signal is provided. The warning signal or the provision of the warning signal is symbolized by the lightning bolt.

If the second decision module E2 detects an adult A, no warning signal is provided. Optionally, the information is provided to the additional module NA.

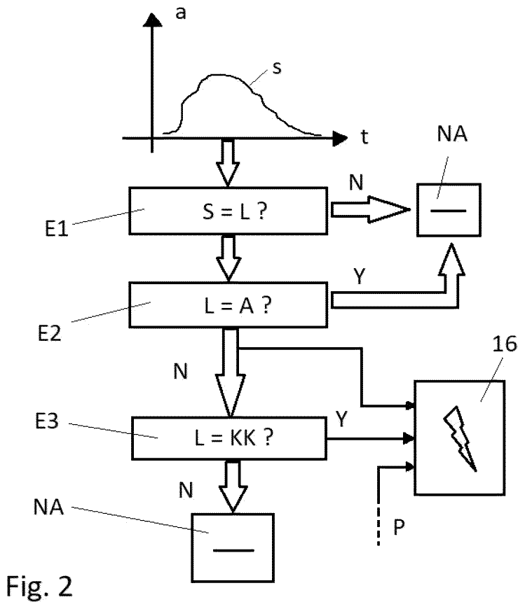

FIG. 2 shows an additional exemplary decision scheme. In addition to the decision scheme presented in FIG. 1, the decision scheme shown here comprises a third decision module E3. The third decision module E3 is advantageously used for the direct determination of a small child KK. If a small child KK but no adult A is detected, a warning signal is provided with the aid of a signal generator 16.

Further, the possibility of including other parameters P such as temperature and the state of the vehicle doors should also be taken into account in the decision whether to output a warning signal. For example, a warning signal can be delayed or suspended if the vehicle doors are open or unlocked. The warning signal is also symbolized by the lightning bolt in FIG. 2.

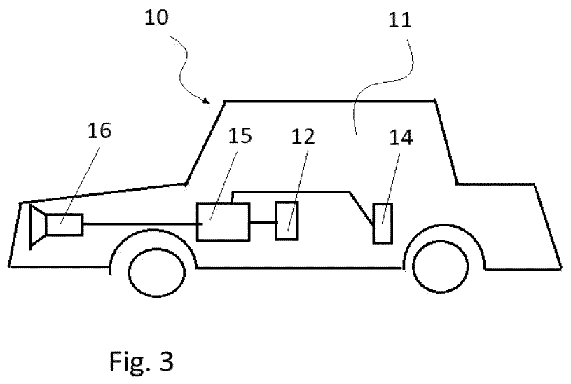

FIG. 3 shows a vehicle 10. Vehicle 10 comprises a transmitter 12 and a receiver 14. Transmitter 12 and receiver 14 monitor passenger compartment 11. Transmitter 12 and receiver 14 are connected to a control device 15. Transmitter 12 and receiver 14 are advantageously designed as UWB components. Control device 15 is connected to a signal generator 16. Signal generator 16 can be designed as a horn or as a communication module, wherein the communication module can enter into communication with a smartphone and a vehicle key so that the smartphone or the vehicle key can emit a warning signal.

Transmitter 12 and receiver 14 are arranged in vehicle 10 in such a way that monitoring of a passenger compartment 11 or a vehicle interior can take place.

In summary, the invention comprises a method and a device for detecting a living being L, in particular a small child KK, in a vehicle 10, wherein a transmitter 12 provides a signal S, wherein the signal S is influenced by the living being L, wherein the influenced signal S is provided to a receiver 14, wherein the receiver 14 provides the signal S to a first decision module E1, wherein the first decision module E1 uses the signal S to ascertain whether a vital state of a living being L is present, wherein the signal S is provided to a second decision module E2 if a living being L is ascertained, wherein the second decision module E2 ascertains whether the living being L is an adult A, wherein if it is ascertained that the living being is not an adult A, a warning signal is output using a signal generator 16. The invention additionally relates to a vehicle 10 having such a device.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for detecting a living being, in particular for detecting a small child in a vehicle, the method comprising:
providing, via a transmitter, a signal that is influenced by the living being;
providing the signal to a receiver that provides the signal to a first decision module;
using, via the first decision module, the signal to ascertain whether a vital state of a living being is present;
providing the signal to a second decision module if a living being is ascertained, the second decision module ascertaining whether the living being is an adult; and
outputting a warning signal via a signal generator if it is ascertained that the living being is not an adult.

2. The method according to claim 1, wherein the signal is an ultra-wideband signal.

3. The method according to claim 1, wherein the first decision module comprises a Fourier transform.

4. The method according to claim 1, wherein the second decision module is based on a learning algorithm.

5. The method according to claim 1, wherein the second decision module decides whether the living being is an adult or a small child based on a respiratory rate and/or a heart rate of the living being.

6. The method according to claim 1, wherein the respective decision module is integrated into a control device or a control device of the vehicle.

7. The method according to claim 1, wherein the signal is provided to a third decision module, wherein the third decision module ascertains whether the living being is a small child.

8. The method according to claim 7, wherein a warning signal is output if a small child is detected and/or if it is ascertained that the living being is not an adult.

9. The method according to claim 7, wherein the third decision module comprises a Fourier transform and/or a learning algorithm.

10. A device for detecting a living being, the device comprising:
a transmitter designed to provide a signal or an ultra-wideband signal;
a receiver designed to receive the signal provided by the transmitter;
a first decision module adapted to receive the signal from the receiver, the first decision module ascertaining whether the signal comprises an indication of a living being;
a second decision module adapted to receive the signal if the indication of the living being is ascertained, the second decision module ascertains whether the living being is an adult; and
a signal generator configured to output a warning signal if the living being is not an adult.

11. The device according to claim 10, further comprising a third decision module, wherein the third decision module ascertains whether the living being is a small child based on the signal provided.

12. A vehicle comprising the device according to claim 10.
